(19) United States
(12) Patent Application Publication
(10) Pub. No.: US 2024/0396691 A1
(43) Pub. Date: Nov. 28, 2024

(54) WIRELESS CONFIGURATION PROPOSAL DEVICE, WIRELESS CONFIGURATION PROPOSAL SYSTEM, WIRELESS CONFIGURATION PROPOSAL METHOD, AND RECORDING MEDIUM

(71) Applicant: NEC Corporation, Tokyo (JP)

(72) Inventor: Makoto OTSU, Tokyo (JP)

(73) Assignee: NEC Corporation, Tokyo (JP)

(21) Appl. No.: 18/645,533

(22) Filed: Apr. 25, 2024

(30) Foreign Application Priority Data
May 22, 2023 (JP) 2023-083888

(51) Int. Cl. H04L 5/00; H04L 41/0806

(52) U.S. Cl. CPC H04L 5/0053; H04L 41/0806

(57) ABSTRACT

Provided is a wireless configuration proposal device including an acquisition unit that acquires customer request information and configuration related information, an extraction unit that extracts a combination of wireless lines exceeding throughput according to a customer request according to a frequency bandwidth according to the customer request, an availability calculation unit that calculates a combination of wireless devices satisfying availability according to the customer request with respect to the extracted combination of the wireless lines, a cost calculation unit that calculates a cost for each combination of the wireless devices in which a configuration of multi-channel aggregation is allowed, a proposal information generation unit that generates proposal information in which the calculated cost is associated with a combination of the wireless devices in which a configuration of multi-channel aggregation is allowed, and an output unit that outputs the generated proposal information.

This application is based upon and claims the benefit of priority from Japanese Patent Application No. 2023-083888, filed on May 22, 2023, the disclosure of which is incorporated herein in its entirety by reference.

### TECHNICAL FIELD

The present disclosure relates to a wireless configuration proposal device, a wireless configuration proposal system, a wireless configuration proposal method, and a program.

### BACKGROUND ART

In a mobile communication network, with an increase in traffic, a sufficient transmission capacity may not be secured only by a band of a single wireless line. Therefore, there are increasing cases where a plurality of wireless lines is bundled and virtually used as one line having a large transmission capacity.

In the present disclosure, a function of bundling a plurality of wireless lines to extend throughput is referred to as “multi-channel aggregation”. In multi-channel aggregation, throughput is extended by bundling a plurality of wireless lines. A packet transmitted to a wireless line is divided on a transmission side. The divided packets are distributed according to the line bandwidth. Transmitted packets are merged at the receiver side.

Patent Literature 1 (WO 2018/179922 A) discloses a communication device that performs multilink communication. In the multilink communication of PTL 1, a plurality of communication paths in which at least one flow is set are simultaneously used with a communication partner device. In the method of PTL 1, a flow is distributed and transmitted to a plurality of lines.

There are many candidates for combinations of wireless devices (hardware) constituting multi-channel aggregation. Therefore, it has been difficult to determine how to combine wireless devices in order to satisfy customer requests. In the multi-channel aggregation, it is necessary to consider a configuration of wireless devices according to a wireless channel owned by a customer.

An object of the present disclosure is to provide a wireless configuration proposal device, a wireless configuration proposal system, a wireless configuration proposal method, and a program capable of providing proposal information including a combination of wireless devices constituting multi-channel aggregation according to a customer request.

### SUMMARY

A wireless configuration proposal device according to an aspect of the present disclosure includes an acquisition unit that acquires customer request information including a customer request and configuration related information used for a configuration of multi-channel aggregation, an extraction unit that extracts a combination of wireless lines exceeding throughput according to the customer request included in the customer request information according to a frequency bandwidth according to the customer request included in the customer request information, an availability calculation unit that calculates a combination of wireless devices satisfying availability according to the customer request included in the customer request information with respect to the extracted combination of the wireless lines, a cost calculation unit that calculates a cost for each combination of the wireless devices in which a configuration of multi-channel aggregation is allowed, a proposal information generation unit that generates proposal information in which the calculated cost is associated with a combination of the wireless devices in which a configuration of multi-channel aggregation is allowed, and an output unit that outputs the generated proposal information.

In a wireless configuration proposal method according to an aspect of the present disclosure, the method includes acquiring customer request information including a customer request and configuration related information used for a configuration of multi-channel aggregation, extracting a combination of wireless lines exceeding throughput according to the customer request included in the customer request information according to a frequency bandwidth according to the customer request included in the customer request information, calculating a combination of wireless devices satisfying availability according to the customer request included in the customer request information with respect to the extracted combination of the wireless lines, calculating a cost for each combination of the radio devices in which a configuration of multi-channel aggregation is allowed, generating proposal information in which the calculated cost is associated with a combination of the wireless devices in which a configuration of multi-channel aggregation is allowed, and outputting the generated proposal information.

A program according to an aspect of the present disclosure causes a computer to execute the steps of acquiring customer request information including a customer request and configuration related information used for a configuration of multi-channel aggregation, extracting a combination of wireless lines exceeding throughput according to the customer request included in the customer request information according to a frequency bandwidth according to the customer request included in the customer request information, calculating a combination of wireless devices satisfying availability according to the customer request included in the customer request information with respect to the extracted combination of the wireless lines, calculating a cost for each combination of the radio devices in which a configuration of multi-channel aggregation is allowed, generating proposal information in which the calculated cost is associated with a combination of the wireless devices in which a configuration of multi-channel aggregation is allowed, and outputting the generated proposal information.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating an example of a configuration of a wireless configuration proposal device according to the present disclosure;

FIG. 2 is a table illustrating an example of wireless band information acquired by the wireless configuration proposal device according to the present disclosure;

FIG. 3 is a table illustrating an example of site information acquired by the wireless configuration proposal device according to the present disclosure;

FIG. 4 is a conceptual diagram for describing an example of throughput of a wireless line;

FIG. 5 is a conceptual diagram for describing an example of availability of a wireless line;

FIG. 6 is a table illustrating an example of wireless data acquired by the wireless configuration proposal device according to the present disclosure;

FIG. 7 is a table illustrating an example of cost data acquired by the wireless configuration proposal device according to the present disclosure;

FIG. 8 is a table illustrating an example of annual precipitation amount data acquired by the wireless configuration proposal device according to the present disclosure;

FIG. 9 is a table illustrating an example of the proposal information generated by a proposal information generation unit of the wireless configuration proposal device of the present disclosure;

FIG. 10 is a flowchart for describing an example of the operation of the wireless configuration proposal device according to the present disclosure;

FIG. 11 is a correlation diagram illustrating an example of information exchange between components constituting the wireless configuration proposal system including the wireless configuration proposal device according to the present disclosure;

FIG. 12 is a block diagram illustrating an example of a configuration of a wireless configuration proposal device according to the present disclosure;

FIG. 13 is a flowchart for describing an example of the operation of the wireless configuration proposal device according to the present disclosure; and

FIG. 14 is a block diagram illustrating an example of a hardware configuration that executes a process according to the present disclosure.

### EXAMPLE EMBODIMENT

Example embodiments of the present disclosure will be described below with reference to the drawings. In the following example embodiments, technically preferable limitations are imposed to carry out the present disclosure, but the scope of this disclosure is not limited to the following description. In all drawings used to describe the following example embodiments, the same reference numerals denote similar parts unless otherwise specified. In addition, in the following example embodiments, a repetitive description of similar configurations or arrangements and operations may be omitted. The directions of the arrows in the drawings illustrate an example, and do not limit the directions of signals and the like.

### First Example Embodiment

First, a wireless configuration proposal device according to a first example embodiment will be described with reference to the drawings. The present example embodiment relates to a function (multi-channel aggregation) of bundling a plurality of wireless lines to extend throughput. The wireless configuration proposal device of the present example embodiment proposes proposal information including a combination of wireless devices (hardware) constituting multi-channel aggregation according to a customer request. Hereinafter, a wireless line may be abbreviated as a line.

### (Configuration)

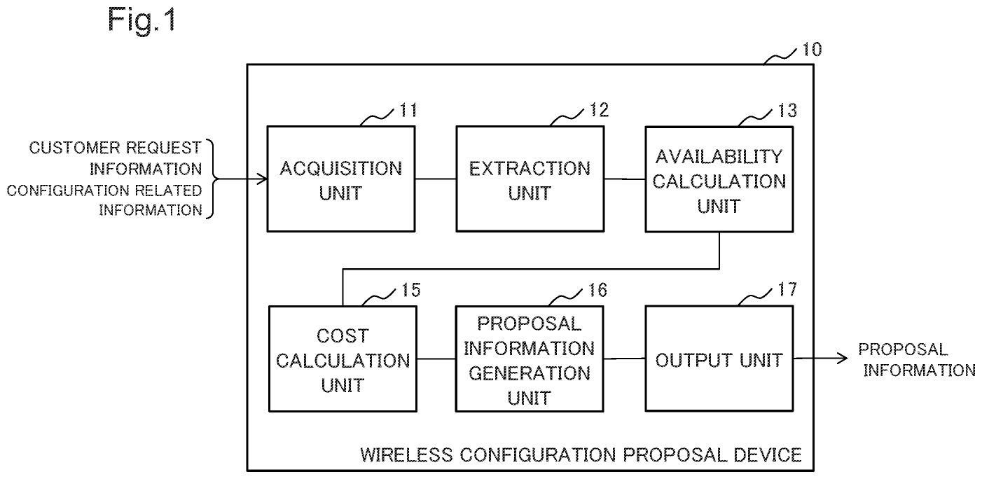

FIG. 1 is a block diagram illustrating an example of a configuration of a wireless configuration proposal device 10 according to the present example embodiment.

Wireless configuration proposal device 10 includes an acquisition unit 11, an extraction unit 12, an availability calculation unit 13, a cost calculation unit 15, a proposal information generation unit 16, and an output unit 17.

The acquisition unit 11 acquires customer request information related to a customer request. For example, the customer request information is input using a terminal device (not illustrated) used by the customer. For example, the acquisition unit 11 acquires the customer request information via a network such as the Internet.

The customer request information includes wireless band information and site information according to the customer request. The wireless band information includes information about a wireless channel owned by the user. The wireless band information includes a frequency bandwidth, a frequency, and a license fee of a wireless line available to a customer. The site information includes position information of a place where the wireless device can be installed, link availability (hereinafter, availability) of the wireless line, and throughput of the wireless line. For example, the customer request information is input using a terminal device (not illustrated) used by the customer.

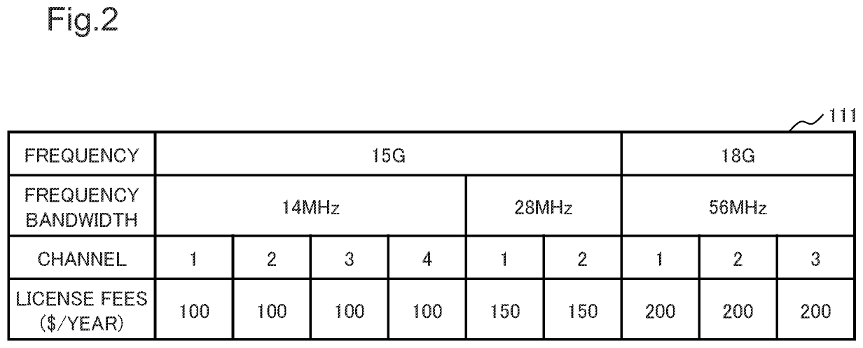

FIG. 2 is a table (wireless band information table 111) illustrating an example of the wireless band information. The wireless band information table 111 includes frequencies available to customers, frequency bandwidths (CS: Channel Separation), channels owned by customers, and license fees for respective channels.

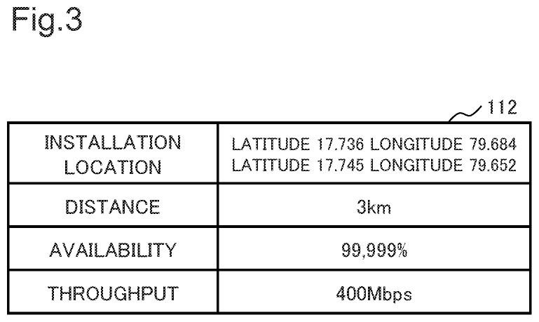

FIG. 3 is a table (site information table 112) illustrating an example of site information. The site information table 112 includes position information about an installation location of a wireless line, a distance between links, availability satisfying a customer request, and requested throughput satisfying the customer request.

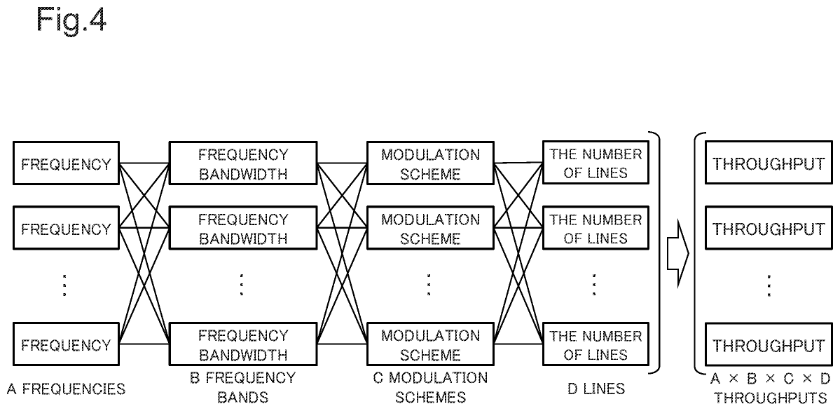

FIG. 4 is a conceptual diagram for describing an example of throughput of a wireless line. In a case where the number of frequencies is A, the number of frequency bands is B, the number of modulation schemes is C, and the number of lines is D, the number of throughputs of multi-channel aggregation is A×B×C×D. That is, as the parameters such as the frequency, the frequency bandwidth, the modulation scheme, and the number of lines increase, the throughput that can be achieved by the bundled lines increases.

When the number of wireless lines is one, throughput is determined by a combination of a frequency bandwidth, a frequency, and a modulation scheme stored in a database server (not illustrated). However, in multi-channel aggregation, since a plurality of wireless lines is combined, when there are N combinations of frequency, frequency bandwidth, and modulation scheme, there are combinations according to the number of lines (N is a natural number). For example, in the case of aggregation of one line, there are N combinations. For example, in the case of aggregation of two lines, there are N² combinations. For example, in the case of aggregation of M lines, there are N^{M} combinations (M is a natural number). However, there is an upper limit to the number of lines that can be aggregated. Aggregation of the number of lines exceeding the upper limit may not be considered.

The acquisition unit 11 acquires the configuration related information accumulated in the database server. The configuration related information includes information used for configuring multi-channel aggregation. The configuration related information includes wireless data, cost data, and annual precipitation amount data. For example, the acquisition unit 11 extracts a combination of wireless lines satisfying the request condition of the throughput based on the wireless band information included in the customer request information. For example, the acquisition unit 11 extracts all combinations of wireless lines that satisfy the request condition of the throughput. For example, the acquisition unit 11 acquires the configuration related information of the modulation scheme in the combination of the frequency and the frequency bandwidth that can be used by the user from the database server. The acquisition unit 11 acquires the configuration related information about the throughput in a case where the frequency, the frequency bandwidth, and the modulation scheme are combined from the database server.

The configuration related information includes the maximum power that can be output for each modulation scheme and the annual precipitation amount information in the area where the wireless devices constituting the multi-channel aggregation are disposed. The acquisition unit 11 acquires the annual precipitation amount data of the area from the database server based on the position information of the site acquired from the terminal device.

The extraction unit 12 extracts a combination of wireless lines exceeding the throughput satisfying the customer request from the wireless band included in the customer request information. For example, the extraction unit 12 extracts all combinations of wireless lines in which a configuration of the multi-channel aggregation is allowed from the extracted combinations of wireless lines. The extraction unit 12 calculates the throughput in all the aggregation patterns. The extraction unit 12 extracts a combination of wireless lines satisfying the throughput requested by the customer. When there is no combination of wireless lines satisfying the throughput requested by the customer, the extraction unit 12 terminates the process. In this case, a value of the achievable throughput may be calculated, and the calculated value may be presented to the customer. In this way, the customer can change the request value of the throughput and request the combination calculation process (proposal information generation process) again. For example, a proposal value related to the value of the achievable throughput may be presented to the customer. For example, the proposal value is the maximum value of the achievable throughput. In this way, the customer can request the combination calculation process (proposal information generation process) again by changing the throughput request value according to the proposal value.

The combination of wireless lines in which a configuration of the multi-channel aggregation is allowed can be determined by a difference in delay between lines or a difference in modem type to be used. The line delay is determined by the type of modem, the type of outdoor wireless device, the frequency, the frequency bandwidth, and the modulation scheme. The delay information in all these configurations is stored in the database server. For example, the acquisition unit 11 requests the database server for delay information in all the extracted combinations of wireless lines. Based on the delay information transferred from the database server, the extraction unit 12 calculates a delay difference between a line having the maximum delay and a line having the minimum delay with respect to a combination of wireless lines in which a configuration of the multi-channel aggregation is allowed. The extraction unit 12 calculates whether a configuration of multi-channel aggregation is allowed for the extracted combination of the wireless lines according to the calculated delay difference. In this way, the extraction unit 12 extracts all combinations of wireless lines in which a configuration of the multi-channel aggregation is allowed. When there is no combination of wireless lines in which a configuration of the multi-channel aggregation is allowed, the extraction unit 12 outputs information indicating that there is no candidate. For example, in addition to the delay difference between lines, there is a combination in which multi-channel aggregation cannot be configured due to a vendor-specific problem such as a difference in an algorithm of multi-channel aggregation according to a modem type. For example, a combination that cannot be configured may be registered in the database server, and a combination that cannot be configured in the extraction by the extraction unit 12 may be excluded.

### [Elements to be Studied]

Elements to be studied in the configuration of a multi-channel aggregation will be described. Specifically, elements to be studied in configuration of the multi-channel aggregation configuration include four factors of throughput, Link Availability (availability), combination restriction, and cost. In the following, these four elements to be studied will be described individually.

### <Throughput>

The throughput of the wireless line is determined by a wireless frequency, a frequency bandwidth, a modulation scheme, and the number of lines. Even when a plurality of lines is bundled by the multi-channel aggregation function, the throughput of the bundled lines is determined by the sum of the throughputs in the lines determined by these parameters. A case where there are two available lines (first line, second line) is assumed. The first line has a line frequency of 15 GHz (gigahertz), a frequency bandwidth of 28 MHz (megahertz), a modulation scheme of quadrature phase shift keying (QPSK), and throughput of 100 Mbps (megabits per second). The second line has a line frequency of 18 GHz (gigahertz), a frequency bandwidth of 56 MHz (megahertz), a modulation scheme of 16 quadrature amplitude modulation (QAM), and throughput of 250 Mbps (megabits per second). When these lines are bundled by using the multi-channel aggregation function, throughput is a sum (350 Mbps) of throughput (100 Mbps) of the first line and throughput (250 Mbps) of the second line.

As described above, when parameters such as a frequency, a frequency bandwidth, and a modulation scheme are uniquely determined, a configuration of a multi-channel aggregation is determined. However, in practice, these parameters are not unique. There is a plurality of combinations (channels) of frequencies and frequency bandwidths owned by customers. There is also a plurality of modulation schemes that can be used in a plurality of channels.

### <Availability>

The availability of the wireless line is determined by the frequency, the frequency bandwidth, the modulation scheme, the antenna size, the inter-link distance, and the atmospheric state. When the availability is calculated for a specific line, the inter-link distance is uniquely determined. There is a plurality of combinations of channels and modulation schemes owned by customers. There is a plurality of antenna size options. Therefore, there is availability by the number of these combinations. In the calculation of the availability, the sequentially changing state of the atmosphere is calculated using the annual precipitation amount of the area. The annual precipitation amount varies depending on the installation place of the device. The number of lines to be combined is not limited to two types. For example, when the modulation scheme of each line is set to be low and the availability is improved instead of decreasing the throughput per line, the number of lines that can be combined can be increased.

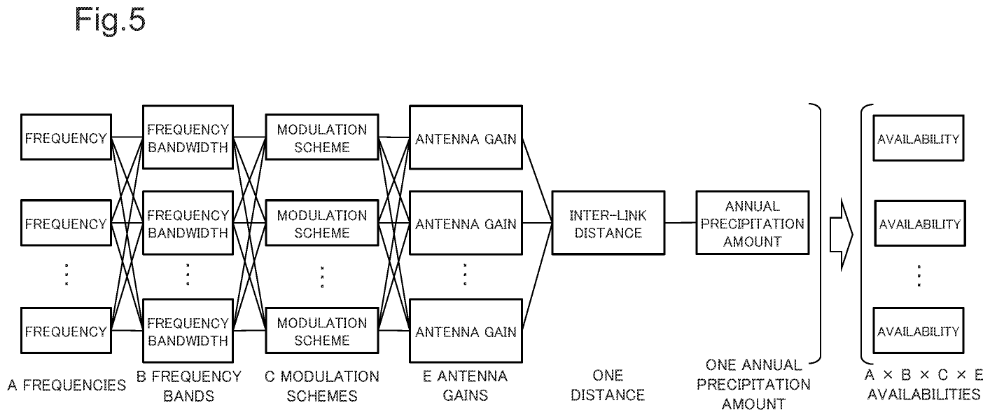

FIG. 5 is a conceptual diagram for describing an example of availability of a wireless line. In a case where the number of frequencies is A, the number of frequency bands is B, the number of modulation schemes is C, and the number of antenna gains is E, the number of availabilities of multi-channel aggregation is A×B×C×E. That is, as the parameters such as the frequency, the frequency bandwidth, the modulation scheme, and the antenna size increase, the availability that can be achieved by the bundled lines increases.

### <Combination Restriction>

When a plurality of lines is bundled by multi-channel aggregation, combination restriction may occur depending on the line. In multi-channel aggregation, each of a plurality of divided packets may be transmitted on different lines. In such a case, divided packets transmitted on each line are merged at a receiving side. When a divided packet is transferred in combination of a line with a very large delay and a line with a very small delay, a packet transmitted on a line with a very small delay waits for a packet transmitted on a line with a very large delay. While waiting for a packet, there is a need for a buffer in which the previously arrived packet is held. In a case where the delay difference is too large, there is a possibility that the packet cannot be held even if there is a large buffer. In such a case, packet loss occurs. Therefore, in a combination of lines having a too large delay difference, lines cannot be bundled by multi-channel aggregation. In addition to the delay difference, lines may not be combined due to a difference in the type of modem used by the line or a difference in the algorithm of multi-channel aggregation implemented in the modem. The combination restriction is very complex and are often not known without checking with the vendor.

### <Cost>

In multi-channel aggregation, it is very difficult to select a combination of wireless lines that satisfies throughput and availability expected by a customer within a combination limit. Further, even when a combination of wireless lines that can achieve throughput and availability that meet customer requests is found, it is necessary to determine the cost of which combination is optimal. The cost related to multi-channel aggregation is mainly estimated by hardware costs and usage fees of used lines. The hardware cost is estimated by an antenna size and an introduction cost (initial cost) of a modem, an outdoor wireless device, and the like. A line usage fee (operation cost) is often determined by a frequency or a frequency bandwidth, but an actual usage fee varies for each country.

Under the combination restriction, it is difficult for the customer to find an optimal cost combination that satisfies the throughput and availability requested by the customer. It is very difficult for a vendor providing a wireless device to make a proposal that satisfies a combination in accordance with a customer request.

The availability calculation unit 13 calculates, based on the site information, the configuration of the wireless devices that satisfies the availability according to the customer request with respect to all combinations of wireless lines in which a configuration of the multi-channel aggregation extracted by the extraction unit 12 is allowed. The availability calculation unit 13 calculates the availability for each channel by using the frequency, the frequency bandwidth, the modulation scheme, the antenna gain, the inter-link distance, and the annual precipitation amount. The antenna gain is a parameter determined by the type and size of the antenna. The antenna gain is acquired from the database server. The availability calculation unit 13 extracts a combination of parameters including the type and size of the antenna satisfying the availability according to the customer request based on these parameters. For example, the availability calculation unit 13 extracts all combinations of parameters including the type and size of the antenna satisfying the availability according to the customer request.

When there is no combination satisfying the availability according to the customer request, the availability calculation unit 13 determines that there is no candidate and ends the process. For example, when there is no combination satisfying the availability according to the customer request, the availability calculation unit 13 may calculate a value of the feasible availability, present the calculated value to the customer, and end the process. In this way, the customer can request the combination calculation process (proposal information generation process) again by changing the request values of throughput and availability. For example, a proposal value related to a value of the achievable throughput or availability may be presented to the customer. For example, the proposal value is the maximum value of the achievable throughput and availability. In this way, the customer can request the combination calculation process (proposal information generation process) again by changing the request value of the throughput and availability according to the proposal value.

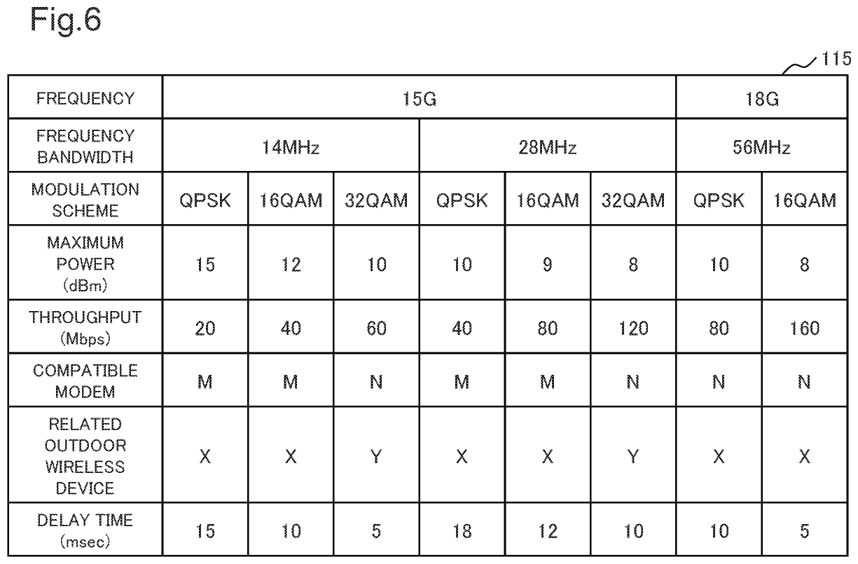

FIG. 6 is a table (wireless data table 115) illustrating an example of wireless data. The wireless data table 115 includes a frequency bandwidth, a modulation scheme, a maximum power, throughput, a compatible modem, a related outdoor wireless device, and a delay time.

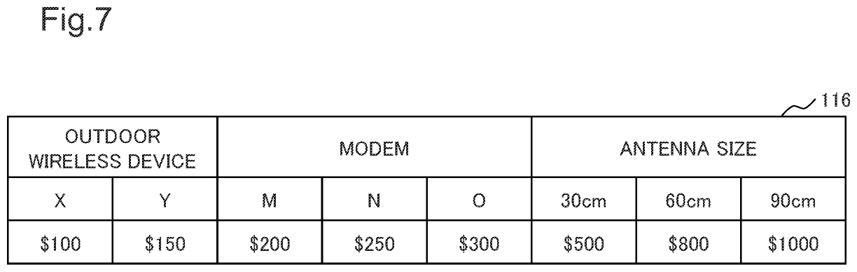

FIG. 7 is a table (cost data table 116) illustrating an example of cost data. The cost data table 116 includes costs for each outdoor wireless device, modem, and antenna size.

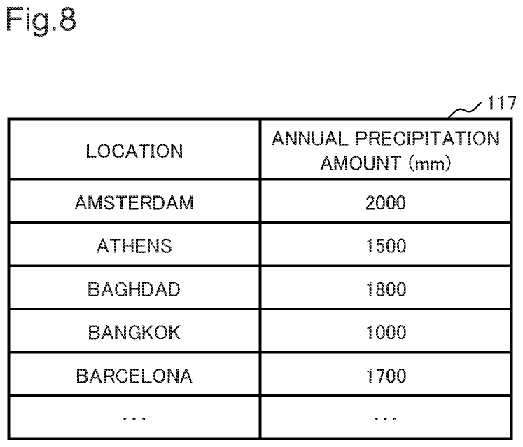

FIG. 8 is a table (annual precipitation amount data table 117) illustrating an example of the annual precipitation amount data. The annual precipitation amount data table 117 includes an annual precipitation amount of a representative city. For example, the annual precipitation amount data table 117 includes annual precipitation amounts in Amsterdam, Athens, Baghdad, Bangkok, Barcelona, and the like. For example, the annual precipitation amount data table 117 may be compiled for each area such as Asia and Europe.

The cost calculation unit 15 calculates a cost for the configuration of the wireless devices satisfying the availability according to the customer request. That is, the cost calculation unit 15 calculates a cost for a combination of wireless devices in which a configuration of the multi-channel aggregation is allowed. For example, the cost calculation unit 15 calculates costs for all combinations of wireless devices in which a configuration of the multi-channel aggregation is allowed. That is, the cost calculation unit 15 calculates a cost for each combination based on a combination of hardware (wireless devices) in which a configuration of the multi-channel aggregation is allowed.

The cost includes an initial cost and an operation cost. The initial cost is a cost for introducing hardware. For example, the cost calculation unit 15 calculates a sum of costs for each modem, outdoor wireless device, and antenna size as an initial cost. The operation cost is a cost related to a license fee (usage fee) of a wireless line that is continuously paid. For example, the cost calculation unit 15 calculates a sum of an initial cost and an operation cost in a predetermined period such as 10 years as a cost. The initial cost is determined by the type and the number of modems, outdoor wireless devices, and antennas included in the multi-channel aggregation configuration. When a device with a low unit price can be configured with a small number of devices, the initial cost is reduced. When the number of lines whose license fee is low can be reduced, the operation cost is reduced.

The proposal information generation unit 16 generates proposal information in which the calculated cost is associated with all combinations of wireless devices in which a configuration of the multi-channel aggregation is allowed. The proposal information includes all combinations of wireless devices in which a configuration of the multi-channel aggregation is allowed. In the proposal information, a cost is associated with each combination of wireless devices in which a configuration of the multi-channel aggregation is allowed.

For example, the proposal information generation unit 16 may rank combinations of wireless devices in which a configuration of the multi-channel aggregation is allowed according to throughput, availability, cost, and the like. The rank of the combination of the wireless devices can be set in any rank. For example, the proposal information generation unit 16 sets a rank of a combination of wireless devices having a high throughput to be high. For example, the proposal information generation unit 16 sets the rank of the combination of the wireless devices with high availability to be high. For example, the proposal information generation unit 16 sets a rank of a combination of wireless devices with low cost to be high.

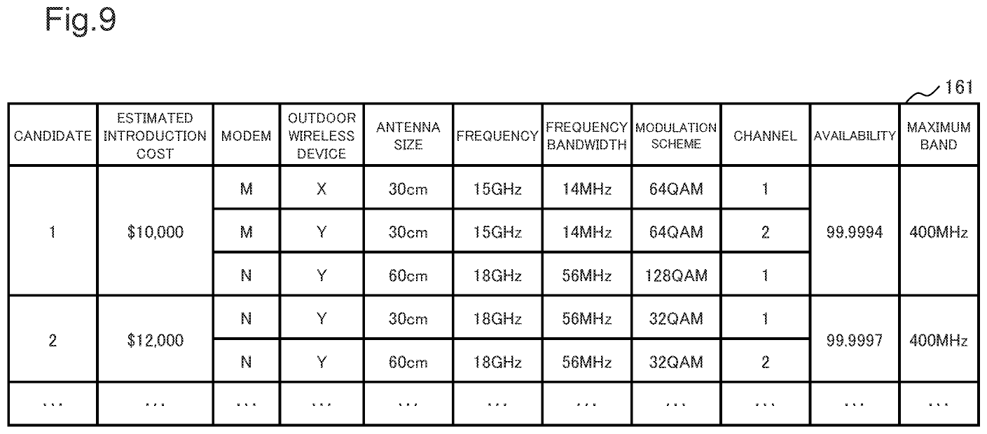

FIG. 9 is a table (proposal information table 161) illustrating an example of the proposal information generated by the proposal information generation unit 16. The proposal information table 161 includes candidates of the configuration satisfying the availability according to the customer request and costs of these candidates.

The output unit 17 outputs the proposal information generated by the proposal information generation unit 16 to the terminal device used by the customer. The proposal information output from the wireless configuration proposal device 10 is displayed on a screen (not illustrated) of the terminal device used by the customer. The user who visually recognizes the proposal information displayed on the screen of the terminal device can check the proposal information generated by the wireless configuration proposal device 10. The proposal information includes a combination of wireless devices constituting multi-channel aggregation according to a request from the user. The user can study the combination of the wireless devices constituting the multi-channel aggregation with reference to the combination of the wireless devices included in the proposal information.

### (Operation)

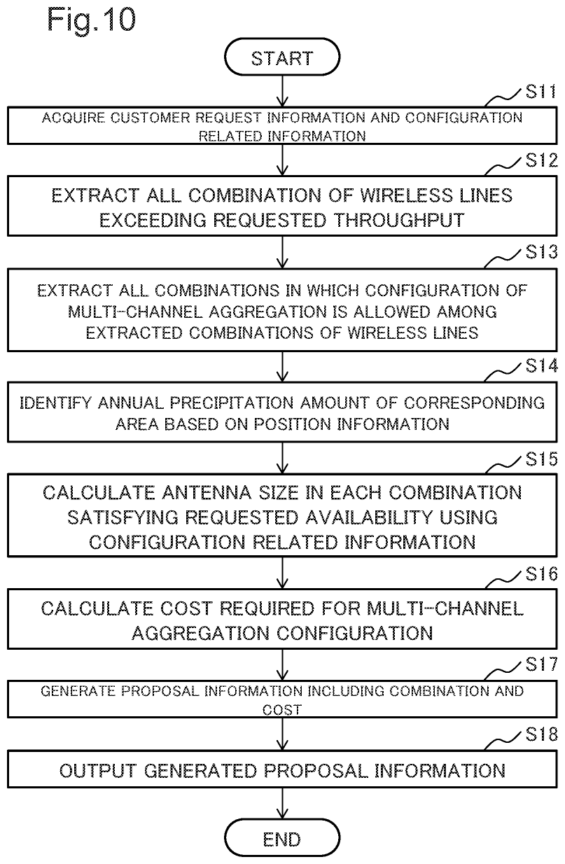

Next, an operation of the wireless configuration proposal device 10 according to the present example embodiment will be described with reference to the drawings. FIG. 10 is a flowchart for describing an example of the operation of the wireless configuration proposal device 10. In the description of the process along the flowchart of FIG. 10, the components of the wireless configuration proposal device 10 will be described as the operation subject. The operation subject of the process along the flowchart of FIG. 10 may be the wireless configuration proposal device 10.

In FIG. 10, first, the acquisition unit 11 of the wireless configuration proposal device 10 acquires the customer request information and the component related information (step S11).

Next, the extraction unit 12 of the wireless configuration proposal device 10 extracts all combinations of wireless lines exceeding the requested throughput (step S12).

Next, the extraction unit 12 of the wireless configuration proposal device 10 extracts all combinations in which a configuration of the multi-channel aggregation is allowed among the extracted combinations of wireless lines (step S13).

Next, the extraction unit 12 of the wireless configuration proposal device 10 identifies the annual precipitation amount of the corresponding area based on the position information included in the site information of the customer request information (step S14).

Next, the availability calculation unit 13 of the wireless configuration proposal device 10 calculates the antenna size in each combination satisfying the requested availability using the configuration related information (step S15).

Next, the cost calculation unit 15 of the wireless configuration proposal device 10 calculates the cost required for the configuration of the multi-channel aggregation (step S16).

Next, the proposal information generation unit 16 of the wireless configuration proposal device 10 generates proposal information including a combination of configurations of a multi-channel aggregation and a cost for each combination (step S17).

Next, the output unit 17 of the wireless configuration proposal device 10 outputs the generated proposal information (step S18). For example, the proposal information output from the wireless configuration proposal device 10 is displayed on a screen (not illustrated) of a terminal device used by the customer.

### (Wireless Configuration Proposal System)

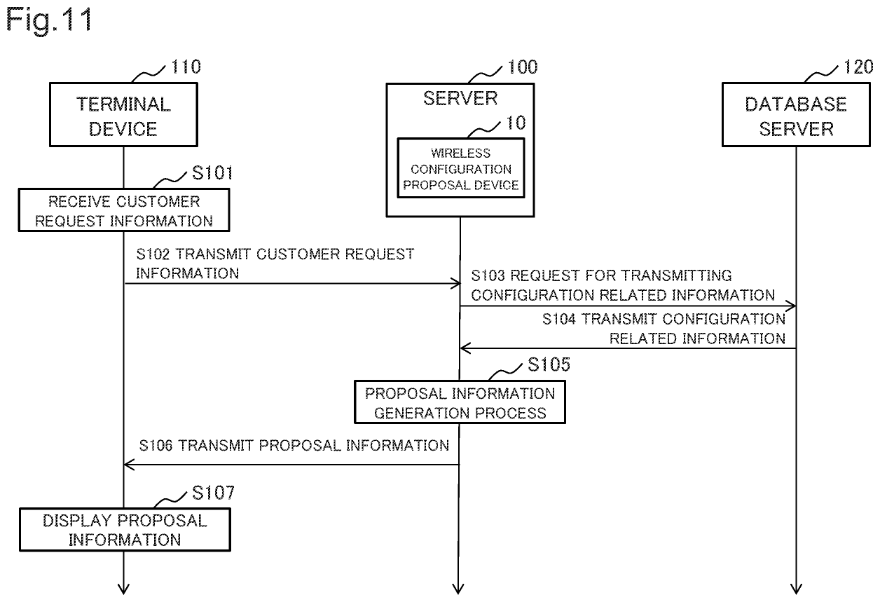

FIG. 11 is a correlation diagram illustrating an example of information exchange between components constituting the wireless configuration proposal system including the wireless configuration proposal device 10. The wireless configuration proposal system includes a server 100, a terminal device 110, and a database server 120. Wireless configuration proposal device 10 is mounted on server 100. For example, the terminal device 110 is achieved by hardware such as a client personal computer (PC). For example, the terminal device 110 may be achieved by a network management system (NMS) that monitors devices on a network. A database in which the configuration related information used to generate the proposal information is stored is mounted in the database server 120.

The terminal device 110 receives the customer request information input by the customer (user) (step S101). The terminal device 110 transmits the received customer request information to the server 100 (step S102).

The server 100 receives the customer request information transmitted from the terminal device 110. In response to the reception of the customer request information, the server 100 transmits a request for transmitting the configuration related information to the database server 120 (step S103).

The database server 120 receives the request for transmitting the configuration related information transmitted from the server 100. In response to the reception of the request for transmitting the configuration related information, the database server 120 transmits the configuration related information to the server 100 (step S104).

The server 100 receives the configuration related information transmitted from the database server 120. The wireless configuration proposal device 10 mounted in the server 100 executes a proposal information generation process using the customer request information and the configuration related information (step S105). The server 100 transmits the proposal information generated by the proposal information generation process to the terminal device 110 (step S106).

The terminal device 110 receives the proposal information transmitted from the server 100. The terminal device 110 displays the received proposal information on a screen (not illustrated) (step S107). The user who visually recognizes the proposal information displayed on the screen of the terminal device 110 can check the proposal information generated by the wireless configuration proposal device 10. The proposal information includes a combination of wireless devices constituting multi-channel aggregation according to a request from the user. The user can study the combination of the wireless devices constituting the multi-channel aggregation with reference to the combination of the wireless devices included in the proposal information.

As described above, the wireless configuration proposal device of the present example embodiment includes the acquisition unit, the extraction unit, the availability calculation unit, the cost calculation unit, the proposal information generation unit, and the output unit. The acquisition unit acquires customer request information including a customer request and configuration related information used for configuring multi-channel aggregation. The extraction unit extracts a combination of wireless lines exceeding throughput according to a customer request according to a frequency bandwidth according to the customer request. The availability calculation unit calculates a combination of wireless devices satisfying the availability according to the customer request with respect to the extracted combination of the wireless lines. The cost calculation unit calculates a cost for each combination of wireless devices in which a configuration of the multi-channel aggregation is allowed. The proposal information generation unit generates proposal information in which the calculated cost is associated with a combination of wireless devices in which a configuration of the multi-channel aggregation is allowed. The output unit outputs the generated proposal information.

The wireless configuration proposal device according to the present example embodiment generates proposal information in which a cost is associated with a combination of wireless devices in which a configuration of the multi-channel aggregation is allowed based on customer request information including a customer request and the configuration related information. According to the present example embodiment, it is possible to provide proposal information including a combination of wireless devices constituting multi-channel aggregation according to a customer request.

According to the present example embodiment, a customer can recognize a configuration of a multi-channel aggregation whose cost is optimized based on line information owned by the customer without inquiring of a vendor. Since the vendor can efficiently provide the device information satisfying the customer request, the opportunity to sell the device can be increased.

The cost calculation unit according to an aspect of the present example embodiment calculates a sum of an initial cost and an operation cost as a cost. The initial cost is a cost related to an antenna size, a modem, and an outdoor wireless device for each combination of wireless devices in which a configuration of the multi-channel aggregation is allowed. The operation cost relates to a usage fee of a wireless line for each combination in which a configuration of the multi-channel aggregation is allowed. According to the present aspect, the cost included in the proposal information can be specifically estimated based on the initial cost and the operation cost.

The availability calculation unit according to an aspect of the present example embodiment extracts a combination of wireless devices according to the type and size of the antenna satisfying the availability according to the customer request. According to the present aspect, a specific combination of wireless devices can be extracted based on the type of antenna satisfying the availability according to the customer request.

The availability calculation unit according to an aspect of the present example embodiment calculates the availability of each channel corresponding to the combination of the frequency and the frequency bandwidth owned by the customer based on the frequency and the frequency bandwidth owned by the customer, the modulation scheme, the annual precipitation amount, the antenna gain, and the inter-link distance. The modulation scheme and the annual precipitation amount are included in the configuration related information. The antenna gain is determined according to the type and size of the antenna. According to the present aspect, it is possible to calculate the availability for each channel according to the frequency and the frequency bandwidth owned by the customer.

The extraction unit according to an aspect of the present example embodiment extracts a combination of wireless lines exceeding throughput according to the customer request included in the customer request information according to the combination restriction of wireless lines. According to the present aspect, wireless lines with limited combinations are excluded, and actually usable wireless lines can be extracted.

The acquisition unit according to an aspect of the present example embodiment acquires delay information in the extracted combination of the wireless lines. The extraction unit extracts, based on the acquired delay information, a combination in a delay difference between the wireless line having the maximum delay and the wireless line having the minimum delay. The extraction unit calculates whether a configuration of multi-channel aggregation is allowed for the extracted combination of the wireless lines. According to the present aspect, it is possible to calculate a combination of wireless lines in which a configuration of the multi-channel aggregation is allowed based on delay information in the combination of wireless lines.

The wireless configuration proposal system according to an aspect of the present example embodiment includes a server, a terminal device, and a database server. The wireless configuration proposal device according to the present example embodiment is mounted in the server. The terminal device receives an input of customer request information including wireless band information and site information. The terminal device transmits the input customer request information to the wireless configuration proposal device. The database server accumulates the configuration related information used for the configuration of the multi-channel aggregation. The database server transmits the configuration related information to the wireless configuration proposal device according to a request from the wireless configuration proposal device. According to the present aspect, it is possible to configure a system that provides proposal information including a combination of wireless devices constituting multi-channel aggregation according to a customer request.

In the wireless configuration proposal system of an aspect of the present example embodiment, proposal information generated by the wireless configuration proposal device according to the customer request information is displayed on the screen of the terminal device. According to the present aspect, the proposal information including the combination of the wireless devices constituting the multi-channel aggregation according to the customer request can be provided to the customer via the screen of the terminal device.

### Second Example Embodiment

Next, a wireless configuration proposal device according to a second example embodiment will be described with reference to the drawings. The wireless configuration proposal device according to the present example embodiment has a configuration in which the wireless configuration proposal device according to the first example embodiment is simplified.

### (Configuration)

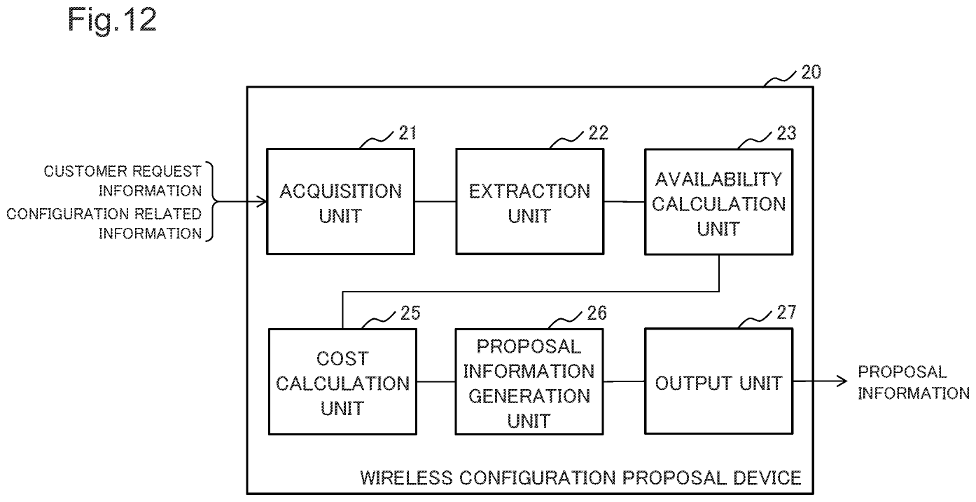

FIG. 12 is a block diagram illustrating an example of a configuration of a wireless configuration proposal device 20 according to the present example embodiment. The wireless configuration proposal device 20 includes an acquisition unit 21, an extraction unit 22, an availability calculation unit 23, a cost calculation unit 25, a proposal information generation unit 26, and an output unit 27.

The acquisition unit 21 acquires customer request information including a customer request and configuration related information used for a configuration of a multi-channel aggregation. The extraction unit 22 extracts a combination of wireless lines exceeding the throughput according to the customer request according to the frequency bandwidth according to the customer request. The availability calculation unit 23 calculates a combination of wireless devices satisfying the availability according to the customer request with respect to the extracted combination of the wireless lines. The cost calculation unit 25 calculates a cost for each combination of wireless devices in which a configuration of the multi-channel aggregation is allowed. The proposal information generation unit 26 generates proposal information in which the calculated cost is associated with a combination of wireless devices in which a configuration of the multi-channel aggregation is allowed. The output unit 27 outputs the generated proposal information.

### (Operation)

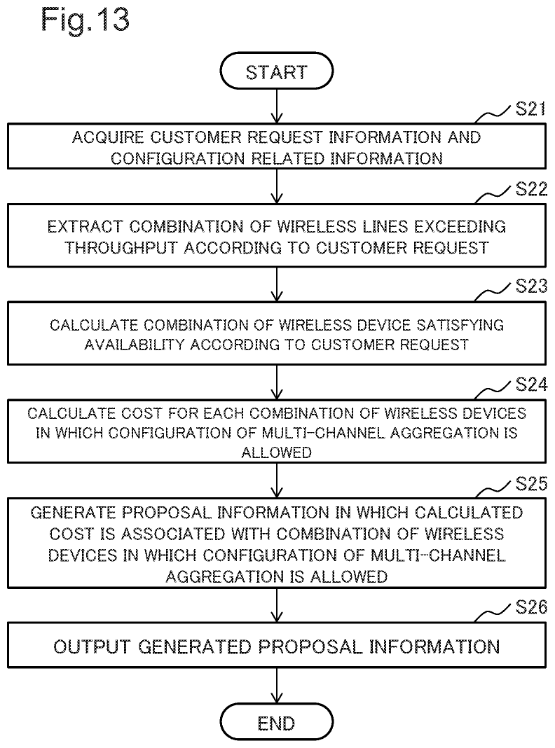

Next, an operation of the wireless configuration proposal device 20 according to the present example embodiment will be described with reference to the drawings. FIG. 13 is a flowchart for describing an example of the operation of the wireless configuration proposal device 20. In the description of the process along the flowchart of FIG. 13, the components of the wireless configuration proposal device 20 will be described as the operation subject. The operation subject of the process along the flowchart of FIG. 13 may be the wireless configuration proposal device 20.

In FIG. 13, first, the acquisition unit 21 of the wireless configuration proposal device 20 acquires the customer request information including the customer request and the configuration related information used for the configuration of the multi-channel aggregation (step S21).

Next, the extraction unit 22 of the wireless configuration proposal device 20 extracts a combination of wireless lines exceeding the throughput according to the customer request according to the frequency bandwidth according to the customer request (step S22).

Next, the availability calculation unit 23 of the wireless configuration proposal device 20 calculates a combination of wireless devices satisfying the availability according to the customer request with respect to the extracted combination of the wireless lines (step S23).

Next, the cost calculation unit 25 of the wireless configuration proposal device 20 calculates a cost for each combination of wireless devices in which a configuration of the multi-channel aggregation is allowed (step S24).

Next, the proposal information generation unit 26 of the wireless configuration proposal device 20 generates proposal information in which the calculated cost is associated with the combination of the wireless devices in which a configuration of the multi-channel aggregation is allowed (step S25).

Next, the output unit 27 of the wireless configuration proposal device 20 outputs the generated proposal information (step S26).

The wireless configuration proposal device according to the present example embodiment generates proposal information in which a cost is associated with a combination of wireless devices in which a configuration of the multi-channel aggregation is allowed based on customer request information including a customer request and the configuration related information. According to the present example embodiment, it is possible to provide proposal information including a combination of wireless devices constituting multi-channel aggregation according to a customer request.

### (Hardware)

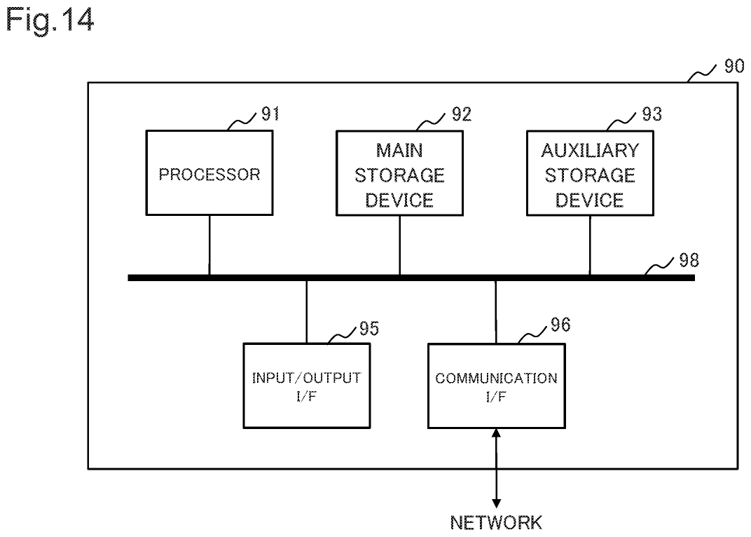

Next, a hardware configuration that executes control and process according to each example embodiment of the present disclosure will be described with reference to the drawings. An example of such a hardware configuration is an information processing device 90 (computer) in FIG. 14. The information processing device 90 in FIG. 14 is a configuration example for executing control and processing of each example embodiment, and does not limit the scope of the present disclosure.

As illustrated in FIG. 14, the information processing device 90 includes a processor 91, a main storage device 92, an auxiliary storage device 93, an input/output interface 95, and a communication interface 96. In FIG. 14 the interface is abbreviated as an interface (I/F). The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops a program (instruction) stored in the auxiliary storage device 93 or the like in the main storage device 92. For example, the program is a software program for executing control and processing of each example embodiment. The processor 91 executes the program developed in the main storage device 92. The processor 91 executes the program to execute control and process according to each example embodiment.

The main storage device 92 has an area in which a program is developed. A program stored in the auxiliary storage device 93 or the like is developed in the main storage device 92 by the processor 91. The main storage device 92 is achieved by, for example, a volatile memory such as a dynamic random access memory (DRAM). As the main storage device 92, a nonvolatile memory such as a magnetoresistive random access memory (MRAM) may be configured/added.

The auxiliary storage device 93 stores various pieces of data such as programs. The auxiliary storage device 93 is achieved by a local disk such as a hard disk or a flash memory. Various pieces of data may be stored in the main storage device 92, and the auxiliary storage device 93 may be omitted.

The input/output interface 95 is an interface that connects the information processing device 90 with a peripheral device based on a standard or a specification. The communication interface 96 is an interface that connects to an external system or a device through a network such as the Internet or an intranet in accordance with a standard or a specification. As an interface connected to an external device, the input/output interface 95 and the communication interface 96 may be shared.

An input device such as a keyboard, a mouse, or a touch panel may be connected to the information processing device 90 as necessary. These input devices are used to input of information and settings. In a case where a touch panel is used as the input device, a screen having a touch panel function serves as an interface. The processor 91 and the input device are connected via the input/output interface 95.

The information processing device 90 may be provided with a display device that displays information. In a case where a display device is provided, the information processing device 90 includes a display control device (not illustrated) that controls display of the display device. The information processing device 90 and the display device are connected via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via an input/output interface 95.

The above is an example of a hardware configuration for enabling control and process according to each example embodiment of the present disclosure. The hardware configuration of FIG. 14 is an example of a hardware configuration that executes control and process according to each example embodiment, and does not limit the scope of the present disclosure. A program for causing a computer to execute control and process according to each example embodiment is also included in the scope of the present disclosure.

A program recording medium in which the program according to each example embodiment is recorded is also included in the scope of the present disclosure. The recording medium can be achieved by, for example, an optical recording medium such as a compact disc (CD) or a digital versatile disc (DVD). The recording medium may be achieved by a semiconductor recording medium such as a Universal Serial Bus (USB) memory or a secure digital (SD) card. The recording medium may be achieved by a magnetic recording medium such as a flexible disk, or another recording medium. In a case where the program executed by the processor is recorded in the recording medium, the recording medium is a program recording medium.

The components of each example embodiment may be combined in any manner. The components of each example embodiment may be implemented by software. The components of each example embodiment may be implemented by a circuit.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed disclosure even if the claims are amended during prosecution.

1. A wireless configuration proposal device comprising:
a memory storing instructions, and
a processor connected to the memory and configured to execute the instructions to:
acquire customer request information including a customer request and configuration related information used for a configuration of multi-channel aggregation;
extract a combination of wireless lines exceeding throughput according to the customer request included in the customer request information according to a frequency bandwidth according to the customer request included in the customer request information;
calculate a combination of wireless devices satisfying availability according to the customer request included in the customer request information with respect to the extracted combination of the wireless lines;
calculate a cost for each combination of the wireless devices in which a configuration of multi-channel aggregation is allowed;
generate proposal information in which the calculated cost is associated with a combination of the wireless devices in which a configuration of multi-channel aggregation is allowed; and
output the generated proposal information.

2. The wireless configuration proposal device according to claim 1, wherein
the processor is configured to execute the instructions to
calculate a sum of an initial cost related to an antenna size, a modem, and an outdoor wireless device for each combination of the wireless devices in which a configuration of multi-channel aggregation is allowed and an operation cost related to a usage fee for each combination of the wireless lines in which a configuration of multi-channel aggregation is allowed as the cost.

3. The wireless configuration proposal device according to claim 1, wherein
the processor is configured to execute the instructions to
extract a combination of the wireless devices according to a type and a size of an antenna satisfying availability according to the customer request.

4. The wireless configuration proposal device according to claim 3, wherein
the processor is configured to execute the instructions to
calculate, based on a frequency and a frequency bandwidth owned by a customer, a modulation scheme and an annual precipitation amount included in the configuration related information, an antenna gain determined according to the type and the size of the antenna, and an inter-link distance, availability of each channel corresponding to a combination of the frequency and the frequency bandwidth owned by the customer.

5. The wireless configuration proposal device according to claim 1, wherein
the processor is configured to execute the instructions to
extract a combination of the wireless lines exceeding throughput according to the customer request included in the customer request information according to a combination restriction of the wireless lines.

6. The wireless configuration proposal device according to claim 4, wherein
the processor is configured to execute the instructions to
acquire delay information in the extracted combination of the wireless lines, and
extract a combination in a delay difference between a wireless line having a maximum delay and a wireless line having a minimum delay based on the acquired delay information, and
calculate whether a configuration of multi-channel aggregation is allowed for the extracted combination of the wireless lines.

7. A wireless configuration proposal system comprising:
a server on which the wireless configuration proposal device according to claim 1 is mounted;
a terminal device that receives an input of customer request information including wireless band information and site information to transmit the input customer request information to the wireless configuration proposal device; and
a database server that accumulates configuration related information used for a configuration of multi-channel aggregation to transmit the configuration related information to the wireless configuration proposal device according to a request from the wireless configuration proposal device.

8. The wireless configuration proposal system according to claim 7, wherein
the proposal information generated by the wireless configuration proposal device according to the customer request information is configured to be displayed on a screen of the terminal device.

9. A wireless configuration proposal method executed by a computer, the wireless method comprising:
acquiring customer request information including a customer request and configuration related information used for a configuration of multi-channel aggregation;
extracting a combination of wireless lines exceeding throughput according to the customer request included in the customer request information according to a frequency bandwidth according to the customer request included in the customer request information;
calculating a combination of wireless devices satisfying availability according to the customer request included in the customer request information with respect to the extracted combination of the wireless lines;
calculating a cost for each combination of the radio devices in which a configuration of multi-channel aggregation is allowed;
generating proposal information in which the calculated cost is associated with a combination of the wireless devices in which a configuration of multi-channel aggregation is allowed; and
outputting the generated proposal information.

10. A computer readable non-transitory recording medium storing a program for causing a computer to execute the steps of:
acquiring customer request information including a customer request and configuration related information used for a configuration of multi-channel aggregation;
extracting a combination of wireless lines exceeding throughput according to the customer request included in the customer request information according to a frequency bandwidth according to the customer request included in the customer request information;
calculating a combination of wireless devices satisfying availability according to the customer request included in the customer request information with respect to the extracted combination of the wireless lines;
calculating a cost for each combination of the radio devices in which a configuration of multi-channel aggregation is allowed;
generating proposal information in which the calculated cost is associated with a combination of the wireless devices in which a configuration of multi-channel aggregation is allowed; and
outputting the generated proposal information.
